(19) United States
(12) Patent Application Publication
(10) Pub. No.: US 2009/0005982 A1
(43) Pub. Date: Jan. 1, 2009

(54) METHOD AND SYSTEM FOR COLLECTING AND DISTRIBUTING DRIVING RELATED INFORMATION OR THE LIKE

(76) Inventor: Hua Luo Yu, Irvine, CA (US)

Correspondence Address: HUA LUO YU, 311 RHYTHM, IRVINE, CA, 92603, US

(21) Appl. No.: 11/770,745

(22) Filed: Jun. 29, 2007

(51) Int. Cl. G01C 21/00

(52) U.S. Cl. 701/213

(57) ABSTRACT

An apparatus which collects, processes and distributes driving related information and a method for controlling the apparatus. The apparatus uses non-dedicated commercial wireless network and non-dedicated terminal device of the network. The network and the terminal device are not made or not meant for transmitting driving related information primarily. The method for transmitting driving related information, comprising steps of a) establishing in-vehicle communication between the non-dedicated terminal device and information collecting device, plus between the non-dedicated terminal device and information presenting device; b) establishing out-of-vehicle communication between the terminal device and information processing and distributing center; c) allowing vehicles to transmit driving related information to the center and vice versa.

### BACKGROUND OF THE INVENTION

1. Field of the Invention

The present invention relates to method and system used to collect and distribute driving related information or the like, from vehicle to information process center and/or from information process center to vehicle. More particularly, information is transmit to and from information process center through wireless network infrastructure which is not made and not meant for transmitting driving condition information dedicatedly.

2. Description of the Prior Art

There are some patents/applications related to setting up system to transfer driving related information, such as Application NO. US20050002347. Those prior arts rely on either cooperative relay between vehicles through ad-hoc network, or road-side facility dedicated for this purpose, or the combination of those two, to transfer driving information.

The ad-hoc network based prior arts have problems including: a) dedicated device need to be attached with vehicle in order to join into the ad-hoc network; b) network is not stable when distance between vehicles changes; c) difficulty of data flow and routing control due to unpredictable density of vehicle in any certain section of road.

The dedicated facility based prior arts have problems including: a) dedicated device need to be attached with vehicle in order to interact with road-side facility, so extra cost is incurred; b) need to deploy dedicated facilities alone the road, such as base station, sensor, power supply, etc. Therefore extra cost and complexity is incurred.

### SUMMARY OF THE INVENTION

Therefore, the present invention has been made in view of the above problems. It is an object of the present invention to provide a method and system which is able to: a) collect driving information of vehicle; b) process and distribute information to vehicle; c) accomplish the purpose without dedicated device and road side facility; d)transfer information with reliability not depends on the distance between vehicles.

There are or will be commercial wireless network and terminal device which are not made and not meant for transferring driving information dedicatedly, examples including cell phone network, Wi-Fi network, etc. Those networks are able to have wide coverage, and provide communication service which is reliable enough to transfer driving related information alone the roads in the coverage area. The present invention accordingly comprises steps and components to leverage those networks and achieve reliable information transfer without dedicated device or facility.

### BRIEF DESCRIPTION OF THE DRAWINGS

A fuller understanding of the nature and objects of the present invention will become apparent upon consideration of the following detailed description taken in connection with the accompanying drawings, wherein:

FIG. 1 is a perspective view of a system embodying present invention.

### DETAILED DESCRIPTION OF THE PREFERRED EMBODIMENTS

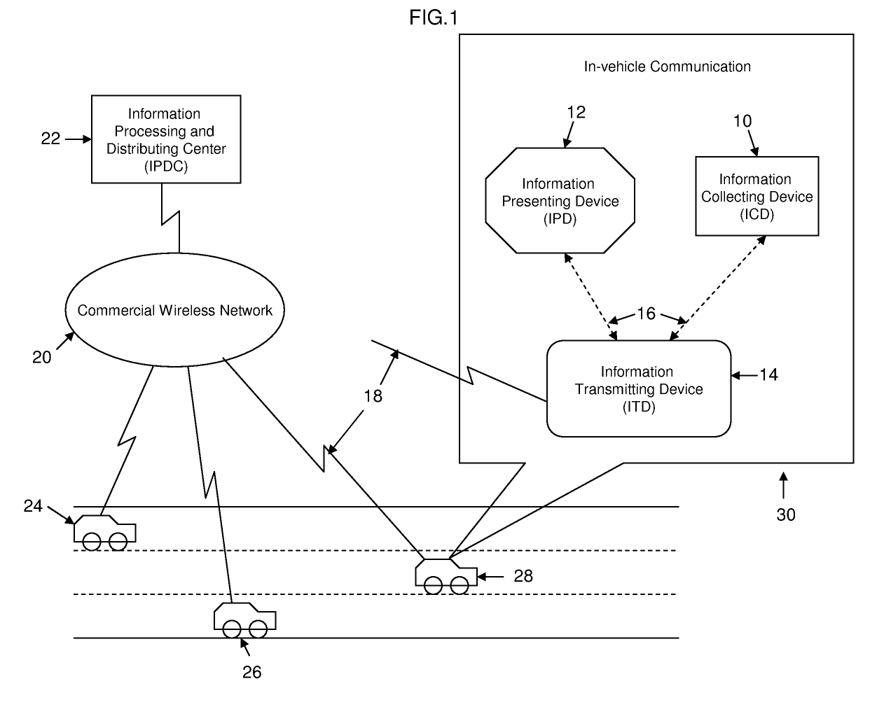

Referring now to the drawing, FIG. 1 illustrates a driving information system embodying the present invention.

Inside vehicle, Information Collecting Device (ICD) 10 collects driving related information, including: velocity, location, temperature, humidity, query for gas price in the gas stations nearby. The examples of the ICD include the GPS navigation system in vehicle. ICD 10 set up in-vehicle communication 16 with Information Transmitting Device (ITD) 14 through wireless or wired link, including BlueTooth, USB. ICD 10 send driving related information to ITD 14 through the in-vehicle communication 16.

ITD 14 is member terminal device of commercial wireless network 20, which is not made or meant for transmitting driving related data primarily. One of the examples of commercial wireless network is cell phone network, in this example, the ITD 14 may be cell phone or PDA joined into the cell phone network. Through commercial wireless network 20, ITD 14 set up out-of-vehicle communication 18 with Information Process and Distributing Center (IPDC) 22. ITD 14 receives driving related information sent by ICD 10 and relay it to IPDC 22.

Neither the commercial wireless network 20 nor the member terminal device ITD 14 is made or meant for transmitting driving related data primarily. By using the intrinsic capability of the commercial wireless network 20 and its member terminal device ITD 14, an embodiment of present invention would not need special terminal device or special communication infrastructure. Therefore, comparing to prior arts based on dedicated road-side facility, the cost and complexity would be reduced significantly. Meanwhile, an embodiment of present invention would enjoy the goodness of commercial wireless network 20 and its member terminal device ITD 14, including wide and reliable coverage, stable signal quality, high availability, high data throughput, mature security, etc. so the drawback of ad-hoc network based prior art would be completely avoided.

IPDC 22 is connected to commercial wireless network 20 through wired or wireless network. It receives driving related information from plurality of vehicles 24, 26, 28, relayed by ITD 14 in each of them. Those vehicles may be on same or different roads. IPDC 22 processes the received information, for example, it may calculate the traffic speed of certain section on a certain road, further derive out warning of traffic congestion, then embed the warning into vehicle-bound driving related information packages. IPDC 22 may also get information from other data sources, for example it may get gas price in a gas station from commercial listing service, then process and compile it into vehicle-bound driving related information packages. After vehicle-bound packages are created, through wireless network 20, IPDC 22 distributes the information packages back to ITD 14 in different vehicles.

Inside vehicle, Information Presenting Device (IPD) 12 set up in-vehicle communication 16 with ITD 14 through wireless or wired link, including BlueTooth, USB, etc. ITD 14 receives information distributed by IPDC and relay it to IPD 12 through the in-vehicle communication 16. IPD 12 processes the information and delivers it to the driver visually or orally.

As shown in FIG. 1, in-vehicle communication 30 is comprised of ICD 10, ITD 14, and IPD 12. ICD, ITD and IPD are all logical units. In an embodiment of present invention, combinations of ICD, ITD, and IPD can be in the same physical module. For example, GPS navigation system of a car could function as ICD and IPD—it could collect driving information as ICD; it could display traffic condition on its LCD screen as IPD. Another example, a GPS-enabled cell phone could function as ICD, ITD and IPD. On the other hand, multiple physical devices on a vehicle could function as same type of logical unit, so there could be more than one ICD, ITD or IPD in a single vehicle. For example, in a single vehicle, both GPS navigation system and rain detecting system could function as ICD.

What is claimed is:

1. A method of collecting and distributing driving related information, comprising the steps of:
a) Establishing in-vehicle communication between Information Collecting Device (ICD) and Information Transmitting Device (ITD) in vehicle; b) Establishing in-vehicle communication between ITD and Information Presenting Device (IPD) in vehicle; c) Establishing out-of-vehicle communication between ITD and Information Processing and Distributing Center (IPDC); d) A plurality of vehicles transmitting driving related information to IPDC and receiving driving related information from IPDC through the in-vehicle and out-of-vehicle communication.

2. The method as set forth in claim 1, further comprising steps of: e1) said ITD establish out-of-vehicle communication with said IPDC through commercial wireless network which is not made or meant for transmitting driving related data primarily, examples of commercial wireless network including cell phone network, Wi-Fi or the like; e2) said ICD collect center-bound driving related information, including velocity, location, temperature, humidity, or query for gas price in the gas stations nearby, and transfer the information to ITD through said in-vehicle communication; e3) said ITD receive the information sent by said ICD, and relay it to said IPDC through said out-of-vehicle communication; e4) said IPDC receive information sent by said ITDs from many vehicles, then process the information, and derive vehicle-bound driving related information from it, including traffic status, weather condition and the like; said IPDC may also get information from other data sources, such as gas price in a gas station from commercial listing service, then process the information and compile it into vehicle-bound driving related information; e5) said IPDC distribute the vehicle-bound driving related information to said ITD through said out-of-vehicle communication; e6) said ITD relay the vehicle-bound driving related information to said IPD through said in-vehicle communication; e7) said IPD present the driving related information received from said ITD.

3. The method as set forth in claim 1, wherein said ITD is member terminal device of commercial wireless network which is not made or not meant for transmitting driving related information primarily, examples of ITD including cell phone, PDA or the like.

4. An apparatus for collecting and distributing driving related information, comprising:
a) Information Collecting Device (ICD) in vehicles collecting driving related information; b) Information Transmitting Device (ITD), including cell phone, PDA or the like, in vehicles; c) Information Processing and Distributing Center (IPDC) receiving, processing, and distributing driving related information from and to vehicles; d) Information Presenting Device (IPD) in vehicles; e) network connections between ICD to ITD, between ITD to IPD, and between ITD to IPDC.

5. The apparatus as set forth in claim 4, wherein e1) said ICD and said IPD establish in-vehicle communication with said ITD; e2) said ITD establish out-of-vehicle communication with said IPDC through commercial wireless network which is not made or meant for transmitting driving related data primarily, examples of commercial wireless network including cell phone network, Wi-Fi or the like; e3) said ICD collect center-bound driving related information, including velocity, location, temperature, humidity, or query for gas price in the gas stations nearby, and transfer the information to ITD through said in-vehicle communication; e4) said ITD receive information sent by said ICD, and relay the information to said IPDC through said out-of-vehicle communication; e5) said IPDC receive information sent by said ITDs from many vehicles, then process the information, and derive vehicle-bound driving related information from it, including traffic status, weather condition and the like; said IPDC may also get information from other data sources, such as gas price in a gas station from commercial listing service, then process the information and compile it into vehicle-bound driving related information; e6) said IPDC distribute the vehicle-bound driving related information to said ITD through said out-of-vehicle communication; e7) said ITD relay the vehicle-bound driving related information to said IPD through said in-vehicle communication; e8) said IPD present the driving related information received from said ITD.

6. The apparatus as set forth in claim 4, wherein said ITD is member terminal device of commercial wireless network which is not made or not meant for transmitting driving related information primarily, examples of ITD including cell phone, PDA or the like.
